(19) United States
(12) Patent Application Publication
(10) Pub. No.: US 2011/0170996 A1
(43) Pub. Date: Jul. 14, 2011

(54) UNIVERSAL LIFT FOR TRANSPORTING A LOAD INTO AND OUT OF A VEHICLE

(76) Inventor: Gert Albert Louis Vrijens, Linter (BE)

(21) Appl. No.: 12/920,718

(22) PCT Filed: Feb. 17, 2009
(86) PCT No.: PCT/EP2009/001100

§ 371 Date: Oct. 21, 2010

(30) Foreign Application Priority Data
Mar. 6, 2008 (EP) 08004149.4

(51) Int. Cl. A61G 3/06; B60P 1/00

(52) U.S. Cl. 414/542; 414/541

(57) ABSTRACT

A universal lift for transporting a load into and out of a vehicle (100) comprises: a) a first tubular member (101) attachable to roof rails (121, 122) on the vehicle (100); b) a second tubular member (102), telescopically movable in and out of the first tubular member (101); c) a carrying arm (106), displaceable along the second tubular member (102); and d) a hinging support (103, 104, 105), telescopically movable in and out of the second tubular member (102).

### FIELD OF THE INVENTION

The present invention generally relates to a device for transporting a load into and out of a vehicle, such as for instance a disabled person that has to be transported under assistance of a caregiver or relative person from its wheelchair to the driver's seat or another location inside the car, or vice versa from a location inside the car to a position in the wheelchair. The device or lift according to the present invention aims at being universal in different aspects: the lift has to be mountable on any kind of car or vehicle without adaptation of the car, the lift must be usable and interchangeable between different cars, and the lift must enable to transport the disabled person (or load) to any location inside the vehicle.

### BACKGROUND OF THE INVENTION

Several devices for transferring an invalid person into and out of a vehicle are known. Lots of them have been commercialized as well, but all of them suffer one or more drawbacks in requiring adaptation to the vehicle wherein or whereon it is used, in being complex, voluminous, heavy and expensive, and in being limited in flexibility. Several car lifts for disabled persons for instance only enable to transfer the invalid person to the front passenger seat of the car, hence limiting the freedom and independence of the disabled person.

A first type of lift for transferring invalid persons into and out of a car rely on lifting bars, a lifting fork or a lifting platform rotationally mounted on a post or supporting structure inside the car. This way, the disabled person can be hinged horizontally either with or without the wheelchair into and out of the car. Examples of such lifts are described in Great Britain Patent GB 2368318 entitled “Fitment of Disabled Persons Lift Apparatus”, U.S. Pat. No. 2,793,768 entitled “Motor Vehicle Hoisting Apparatus for Invalids”, and U.S. Pat. No. 3,983,584 entitled “Vehicle Invalid Lift Device”.

This first type of devices for transferring invalids into and out of a vehicle are limited in use to specific cars wherein the post or supporting structure can be mounted. The mounting of the post or supporting structure typically requires adaptation of the car, the door, the dashboard, etc. by a technician and therefore is a costly operation. Once mounted, the device or lift cannot be used on another vehicle, e.g. a second car owned by the relatives of the disabled person or a new car bought by the invalid or its relatives, and the lift cannot be used at another position within the same car. The lift cannot be removed from the car and usually consists of a heavy, voluminous structure that is always present at one particular location inside the car.

A second type of lifts for transferring invalid persons into and out of a vehicle relies on a mechanical structure integrated in the roof of the car or attached to the interior roof of the car. Examples of such lifts are described in French Patent FR 2553046, entitled “Dispositif pour charger et décharger une personne handicapée dans une voiture à l'aide d'un système de pignons à chaine”, German Utility Model DE 202004006861U entitled “Aushebevorrichtung für eine in einem Kraftfahrzeug sitzende Person”, U.S. Pat. No. 4,544,321 entitled “Apparatus for Moving a Wheelchair into and out of an Automobile”, UK Patent Application GB 2 105 294 entitled “Extensible and Retractable Gantry for Mounting in a Vehicle”, German Utility Model DE 8815282U entitled “Fahrzeug-Krankensitz, insbesondere für Rollstuhlfahrer”, U.S. Pat. No. 5,743,702 entitled “Method and Apparatus for a Vehicle Mounted Hoisting System, and UK Patent Application GB 2 268 729 entitled “Delivery Vehicle Goods Handling”.

This second type of invalid lifts for cars has as general drawback that it can only be installed in or on certain types of cars whose interior is sufficiently high to mount the structure to the roof and whose roof is sufficiently stable and strong to support the forces exercised thereon by the lift when transferring a person or load into or out of the car. In addition, this second type of lift requires adaptation of the car and installation of the lift by a technician which is costly. The lift is typically positioned to enable transferring the invalid person to the back seat of the car, or into the back of the vehicle in case of a van, emergency car, bus or truck, and does not provide the flexibility to be re-positioned to transfer an invalid person to another location, e.g. the driver's seat inside the same car. This second type of lift, integrated in the roof or attached to the interior roof of the car, can also not be interchangeably used with different cars.

A more universal car lift is described in Japanese Patent Application No. JP 2001-037811 from applicant Anayama Create. This lift consists of a cross frame (50 in FIG. 1 of JP 2001-037811) attachable to roof rails on the roof of a car, a guide rail (20 in FIG. 1 of JP 2001-037811), a hinge (20D in FIG. 1 of JP 2001-037811) and a supporting stanchion (10 in FIG. 1 of JP 2001-037811). In the stowed position illustrated by FIG. 2 of JP 2001-037811, the cross frame (50) and the various portions of the guide rail (20A, 20B, 20) are placed on top of each other hence leaving a rather bulky, voluminous and heavy structure on top of the vehicle's roof. This is shown explicitly in FIG. 6 of JP 2001-037811 where the roof of a car holding the stowed away invalid lift is drawn. Although the lift known from JP 2001-037811 is roof mountable on most types of cars, and interchangeable between cars, it is a rather bulky, voluminous, heavy and inelegant device on top of the car, which is rather cumbersome and user-unfriendly in usage. This known lift further cannot be mounted by a single person like a relative or caregiver of the invalid person. Installation of the heavy and bulky structure requires involvement of at least two people.

A similar, rather heavy, roof-mountable device for transporting loads into and out of a vehicle, with comparable drawbacks is described in European Patent EP 0 027 638 from proprietor Idé-Produktion Carin AB.

It is an objective of the present invention to provide a universal lift for transporting a load such as a disabled person into and out of a vehicle which overcomes the drawbacks of the above identified known lifts. In particular, it is an objective to provide a lift whose mounting does not require adaptation of the vehicle, which can be used to transfer the load to different positions or seats inside the vehicle, which can be used interchangeable on different cars, and which does not require a particular type or brand of car. In addition, it is an objective of the present invention to provide a lift which is compact in size, lightweight, stable and safe, inexpensive and user-friendly.

### SUMMARY OF THE INVENTION

According to the present invention, the above mentioned objectives are realized and the shortcomings of the known prior art solutions are resolved by a universal lift for transporting a load into and out of a vehicle as defined by claim 1, the universal lift comprising:
a. a first tubular member attachable to roof rails on said vehicle;
b. a second tubular member, telescopically movable in and out of the first tubular member;
c. a carrying arm, displaceable along the second tubular member; and
d. a hinging support, telescopically movable in and out of the second tubular member.

Indeed, thanks to the telescopic second tubular member and telescopic, hinging support, the lift according to the present invention remains compact, elegant, and user-friendly to open or stow away. When stowed away, only the first tubular member or mother tube remains visible on top of the car roof. Since the mother tube is attachable to roof rails on the vehicle, the lift according to the invention can be mounted and used on any type of car as long as the car is equipped with fixed roof rails or can be equipped with detachable roof rails that can carry the lift. Depending on the position on the roof rails where the lift according to the present invention is attached, the lift can be used to transfer an invalid or load into or from the driver's position, the front passenger position, the back passenger positions or even the trunk or back compartment of the vehicle. A single lift according to the present invention can be used interchangeably on plural vehicles, or can be re-used when a new car is bought. Thanks to its compactness, the lift according to the present invention is mountable by a single person, e.g. the caregiver or a relative of the invalid person.

It is noticed that the carrying arm may optionally be dismountable from the lift in such a way that when stowed away, only the first tubular member or mother tube remains visible on top of the roof. For long distance travel for instance, the carrying arm may be dismounted and hidden in the back or trunk of the car.

Optionally, the lift for transporting a load into and out of a vehicle according to the present invention comprises at least one rod member attachable to cross bars mounted on the roof rails, the first tubular member being attachable to the rod member. This optional aspect is defined by claim 2.

Further optionally, the universal lift for transporting a load into and out of a vehicle according to the present invention comprises two rod members attachable to cross bars mounted on the roof rails, the first tubular member being attachable to the two rod members. This optional aspect is defined by claim 3.

Through a single rod mounted in the direction from the front of the car to the back of the car, and attached more or less in the middle of cross bars that are mounted on the roof rails, the lift according to the present invention can be attached to the single rod such that it enables transferring a load or invalid person in the back of the car. When two (or more) rods are mounted in the direction from the front of the car to the back of the car in between cross bars mounted on the roof rails, the car lift according to the present invention can be attached to those rods such that a load or invalid person can be transferred onto any seat inside the car. The rods provide an extension of the roof rails in upfront direction for those types of cars whose windshield extends to a point where the lift should be mounted in order to enable transfer of the invalid person to or from a front seat in the car. Similarly, the rods provide an extension of the roof rails in backward direction for those types of cars whose rear window extends to a point where the lift should be mounted in order to enable transfer of an invalid person to or from a back seat in the car. The rods in other words further expand the universality of the lift according to the present invention rendering it useable on more aerodynamically designed types of cars, sports cars or SUV vehicles that have a rather small roof and consequently rather short roof rails which as such do not enable to position the lift to transfer loads to or from any location inside the car.

Another advantage of the optional rods is that they enable to mount the lift or mother tube diagonally or even tilted on the roof of the vehicle, which may be advantageous for instance for cars with relatively small doors.

Another optional aspect of the universal lift for transporting a load into and out of a vehicle according to the present invention, defined by claim 4, is that the first tubular member is made out of aluminium and has a maximum diameter of 60 millimeters.

Through the use of aluminium for the first or mother tube, and preferably also for the second or daughter tube and for the hinging support, a lightweight but stable and secure mechanical structure is obtained. The maximum diameter of 60 millimeters guarantees elegancy when stowed away, e.g. while driving a car equipped on its roof with the lift according to the present invention.

Still optionally, the universal lift for transporting a load into and out of a vehicle according to the present invention has a maximum aggregate weight of 7.5 kilograms. This option is covered by claim 5.

When using aluminium or lightweight composite materials that provide the strength and stability needed to secure the lift, the aggregate weight of the mother tube, daughter tube, hinging support and carrying arm can be kept below 7.5 kilograms, not including the optional rod(s). This way, opening or stowing away of the lift by the caregiver or relative person is further eased because no heavy mechanical parts have to be handled, displaced, rotated or hinged. Thanks to its lightweight structure, the lift according to the present invention also has minor impact on the aggregate weight and consequently on the aerodynamics, fuel consumption, roadholding, stability, brake distance and safety of the vehicle whereon the lift is mounted.

Further optionally, the universal lift for transporting a load into and out of a vehicle according to the present invention may comprise a hoist, securely attachable to the carrying arm and displaceable along the carrying arm. This option is defined by claim 6.

Such hoist, like for instance the pocket-sized lever hoist LX003 from KITO Corporation may slide or roll onto the carrying arm. The carrying arm may be foreseen at its open end with a mechanical structure that prevents sliding back or rolling back of the hoist as soon as it experiences a vertical downward force from a load. The hoist may be manually detachable such that it can be stowed away in the back or trunk of the vehicle.

Yet another option of the universal lift for transporting a load into and out of a vehicle according to the present invention is that the lift may comprise a bag for carrying a disabled person, the bag being securely attachable to the hoist. This optional aspect of the lift is defined by claim 7.

In order to be able to lift an invalid person from its wheelchair and position the invalid person in the vehicle, or vice versa, the lift according to the present invention may be supplemented with a bag, attachable to the hoist on the one hand, and standardized and approved for carrying a sitting, disabled person on the other hand. Just like the hoist, the bag will be removed from the lift and stowed away in the back or trunk of the car when the lift is not in use.

### BRIEF DESCRIPTION OF THE DRAWINGS

FIG. 1 is a schematic drawing illustrating the parts of a first embodiment of the universal lift according to the present invention;

FIG. 2 is a detailed technical drawing of a second embodiment of the universal lift according to the present invention; and

FIG. 3, FIG. 4 and FIG. 5 respectively show a side view, top view and front view of a vehicle carrying a third embodiment of the universal lift according to the present invention.

### DETAILED DESCRIPTION OF EMBODIMENT(S)

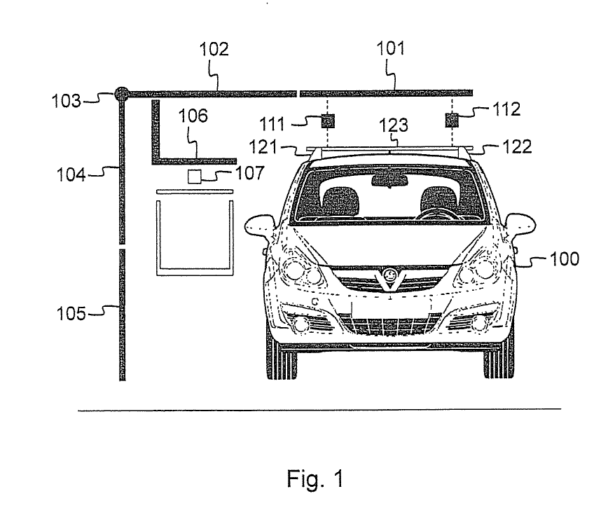

FIG. 1 schematically shows the different parts of a first embodiment of the invented lift mounted on the roof rails 121 and 122 of a regular car 100. The lift contains a first tubular member or mother tube 101, attachable via roof supports 111 and 112 to the roof rails 121 and 122, or to cross bars mounted on the roof rails 121 and 122. The roof supports 111 and 112 may comprise rods and universal fasteners, e.g. clips or clamps, enabling to securely fix the mother tube 101 to the roof rails 121 and 122. The lift further contains a second tubular member or daughter tube 102 whose diameter and length are such that it telescopically moves into and out of the mother tube 101. The mother tube 101 and daughter tube 102 thereto are foreseen with a telescope connection, and their respective lengths are chosen such that the daughter tube 102 can be entirely moved into the mother tube 101 when stowed away. FIG. 1 further shows a carrying arm 106 that slides or rolls along the daughter tube 102. This carrying arm 106 is further equipped with a hoist 107 whereto a frame or bag carrying the load is attached. The lift further contains a hinge 103 whose size is such that it can slide into the daughter tube 102. At last, the lift drawn in FIG. 1 contains a support consisting of a first telescopic tube 104 and a second telescopic tube 105. The diameters and lengths of the first telescopic tube 104 and second telescopic tube 105 are chosen such that the second telescopic tube 105 can move into and out of the first telescopic tube 104. Further, the first telescopic tub 104 together with the hinge 103 can move into and out of the daughter tube 102 after being hinged in horizontal position. The support 104, 105 provides stability to the lift in case a heavy person or load is transferred into or out of the vehicle 100, reduces the rotational forces applied to the vehicle when transferring a load into or out of the vehicle, and prevents the daughter tube 102 from deflecting when carrying a load.

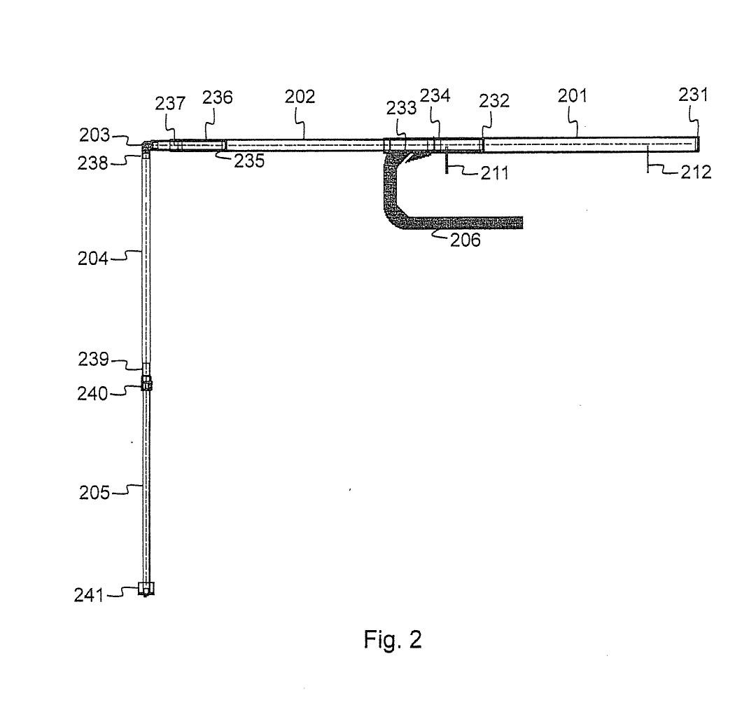

FIG. 2 illustrates in more detail the different parts of a second embodiment of the lift according to the invention. The lift contains an aluminium mother tube 201 with external diameter of 60 millimeters and a length of 1050 millimeters. The internal diameter is supposed to be 52 millimeters. The mother tube 201 is provided with a stop 231 that fits in the 52 millimeters internal diameter of the mother tube 201 and that is for instance made out of polyamide. FIG. 1 further shows a bearing bush 233 sunken in the mother tube 201. The bearing bush 233 has an external diameter of 55 millimeters and fits on the daughter tube 202. The bearing bush 233 may for example be made out of PTFE (polytetrafluoroethylene or teflon). The aluminium daughter tube 202 has a diameter of 50 millimeters and a length of 1250 millimeters. It is foreseen with a telescope connection enabling to telescopically slide the daughter tube 202 in and out of the mother tube 201. The daughter tube 202 is preferably anodized, and contains a bearing bush 232 sunken with the exterior surface of the daughter tube 202. The bearing bush 232 has an external diameter of 52 millimeter and is supposed to sleeve in the mother tube 201. The bearing bush 232 may also be made out of PTFE. Near its other end, the daughter tube 202 contains a second bearing bush 237, sunken in the daughter tube 202. This second bearing bush 237 may also be made out of PTFE and fits over the telescopic connection in stowed away position. The lift drawn in FIG. 2 further contains a hinging support. This hinging support consists of a hinging tube 236 with bearing bush 235, a horizontal hinging part 203, a vertical hinging part 238, an upper telescopic support tube 204 and a lower telescopic support tube 205 with base 241. The aluminium hinging tube 236 has a diameter of 40 millimeters and a length of 300 millimeters. At one end, the bearing bush 235 is sunken with the exterior surface of the hinging tube 236. The bearing bush 235 may be made out of PTFE and is supposed to sleeve in the daughter tube 202. At the other end, the hinging tube 236 is foreseen with the horizontal hinging part 203, made out of polyamide and moulded or pressed onto the hinging tube 236. Similarly, the vertical hinging part 238 may be moulded or pressed onto the upper telescopic support tube 204. Whereas the horizontal hinging part 203 may have a diameter of 32 millimeters, the diameter of the vertical hinging part may be 29 millimeters. The aluminium upper telescopic support tube 204 has a 35 millimeters diameter, a 900 millimeters length, and is interconnected with the lower telescopic support tube 205 through a telescopic connection 239 and a rubber ring 240. The lower telescopic support tube 205 has a diameter of 28 millimeters and a length of 900 millimeters, and is provided with a telescopic base or foot 241. FIG. 2 further shows the carrying arm 206 welded on a hollow tube with internal diameter of 50 millimeters that slides along the daughter tube 202. By sliding the carrying arm 234, 206 along the daughter tube 202, the load is horizontally transferred into or out of the vehicle whereon the lift is mounted through roof supports 211 and 212.

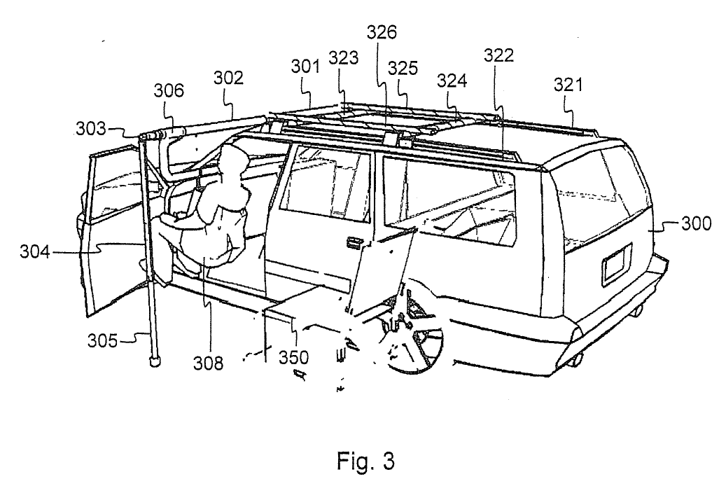

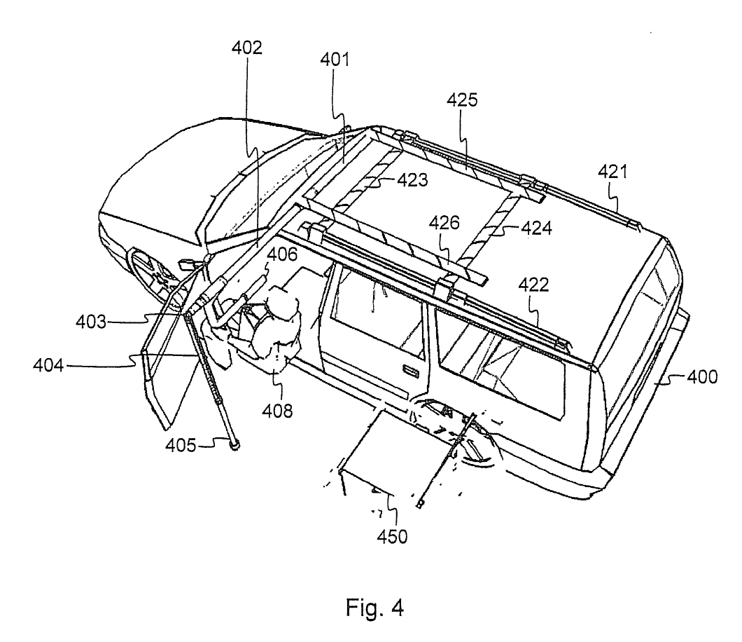

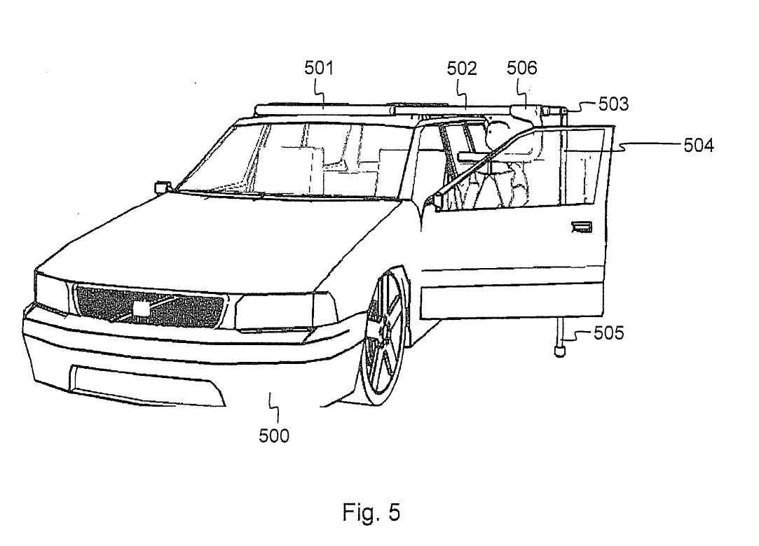

FIG. 3, FIG. 4 and FIG. 5 illustrate the operation of a third embodiment of the lift according to the invention from different angles. FIG. 3 is a side view, FIG. 4 is a top view and FIG. 5 is a front view of the same car, equipped with the lift. The corresponding references in the different figures denote the same parts: the mother tube of the lift is for instance referenced by 301 in FIG. 3, 401 in FIG. 4 and 501 in FIG. 5. The same rational is applied when referencing other parts of the lift in the different figures.

In order to lift an invalid person from its wheelchair 350 or 450, onto the driver's seat in the car 300, 400 or 500, the lift according to the present invention is opened by a caregiver or relative assisting the invalid. The daughter tube 302, 402 or 502 thereto is telescopically moved out of the mother tube 301, 401 or 501 to horizontally extend the lift. Further, the lower part 305, 405 or 505 and the upper part 304, 404 or 504 of a support are telescopically moved out of the daughter tube 302, 402 or 502, and the support is hinged to vertically support the open end of the daughter tube 302, 402 or 502. The caregiver or relative person thereto uses the hinge 303, 403 or 503, and ensures that the base at the lower part of the support securely touches soil, e.g. the street, a sidewalk, the parking lot, a step, etc. Since the lower part 305, 405 or 505 telescopically moves into and out of the upper part 304, 404 or 504, the height of the vertical support can be adjusted to the particular situation, as a result of which the daughter tube 302, 402 or 502 can stay in horizontal position. In order to be lifted from his/her wheelchair 350 or 450, the invalid person is placed in a sitting bag 308 or 408 that is securely attached to the carrying arm 306, 406 or 506 of the lift through for instance a hoist. When the wheelchair is pulled back or when the hoist is lifted, the invalid person will be floating. The caregiver or assisting relative now only has to slide the carrying arm 306, 406 or 506 horizontally such that the invalid person is transferred into the vehicle. There, the hoist can be lowered again to put the invalid person at rest on the driver's seat.

In FIG. 3, FIG. 4 and FIG. 5, an embodiment of the invented is lift is shown that is provided with two rods, respectively denoted by 325 and 326 in FIG. 3, and 425 and 426 in FIG. 4. This rods are fixed in the longitudinal direction of the vehicle onto cross bars 323 and 324, or 423 and 424 attached in cross direction on the roof rails 321 and 322, or 421 and 422. The rods 325 and 326, or 425 and 426 provide for an extension of the roof rails to the frontage of the car and enable the mother tube 301 or 401 to be located such that the invalid person can be transferred onto or from the front seats of the car. In a similar way, the rods could be mounted on cross bars attached to the roof rails of a different car to virtually extend the roof rails to the rear side of the vehicle thereby enabling the invalid person to be transferred into and from the back seats of a vehicle whose back doors and roof rails are positioned relative to one another in such a way that direct attachment of the mother tube to the roof rails does not enable such transfer.

It is noticed that the carrying arm may be rotationally mounted on the daughter tube such that it can be rotated in horizontal position and stowed away on the roof of the car. The carrying arm optionally also may be dismountable from the daughter tube, such that it can be hidden, eventually together with the hoist and sitting bag, in the back or trunk of the car. In particular for long distance travelling, the latter option is advantageous as it leaves only the mother tube visible on the roof of the car when the lift is stowed away.

As already mentioned above, the universal attachment of the lift according to the present invention onto the roof rails, e.g. through clips or clamps eventually in combination with rods and/or cross bars, allows to displace the lift from one car to another, to use the lift on virtually any type of car as long as the car is equipped with or can be equipped with roof rails, and allows to use the lift for transferring loads into and from any location in the car. In case a single rod is used and the mother tube is mounted in longitudinal direction of the vehicle along this single rod, the lift according to the present invention can even be used to transfer loads into and from the boot or trunk of the car. This may be advantageous for instance when the lift according to the present invention is used on a van or emergency vehicle where the seats or location where a person has to be transferred to/from may be reachable from the back of the vehicle.

Although the present invention has been illustrated by reference to specific embodiments, it will be apparent to those skilled in the art that the invention is not limited to the details of the foregoing illustrative embodiments, and that the present invention may be embodied with various changes and modifications without departing from the spirit and scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1-7. (canceled)

8. A universal lift for transporting a load into and out of a vehicle having roof rails, comprising:
a first tubular member attachable to the roof rails;
a second tubular member, telescopically movable in and out of said first tubular member;
a carrying arm, displaceable along said second tubular member; and
a hinging support, telescopically movable in and out of said second tubular member.

9. The universal lift according to claim 8, comprising at least one rod member attachable to cross bars mounted on said roof rails, said first tubular member being attachable to said at least one rod member.

10. The universal lift according to claim 9, comprising two rod members attachable to cross bars mounted on said roof rails, said first tubular member being attachable to said two rod members.

11. The universal lift according to claim 8, wherein said first tubular member is made out of aluminium and has a maximum diameter of 60 millimeters.

12. The universal lift according to claim 8, wherein said lift has a maximum aggregate weight of 7.5 kilograms.

13. The universal lift according to claim 8, comprising a hoist securely attachable to said carrying arm and displaceable along said carrying arm.

14. The universal lift according to claim 13, comprising a bag adapted to carry a disabled person, said bag being securely attachable to said hoist.
